(19) United States
(12) Patent Application Publication
(10) Pub. No.: US 2014/0025529 A1
(43) Pub. Date: Jan. 23, 2014

(54) Systems and Methods for Generating Three-Dimensional Product Configuration

(71) Applicant: ATLATL SOFTWARE, LLC, Charleston, SC (US)

(72) Inventors: Robert Honeycutt, Pawleys Island, SC (US); Matthew Carter, Columbia, SC (US); Fred Harmon, Sumter, SC (US)

(21) Appl. No.: 13/833,024

(22) Filed: Mar. 15, 2013

Related U.S. Application Data
(60) Provisional application No. 61/674,612, filed on Jul. 23, 2012.

(51) Int. Cl. G06Q 30/06

(52) U.S. Cl. CPC G06Q 30/0621
USPC 705/26.5

(57) ABSTRACT

Computer-based systems and methods for the creation and design of custom products in real time that provides sales implementation functionality are provided. A visual design tool can provide a user the capability to configure in real time a three-dimensional product configuration using gestural, affordance-based construction techniques. The visual design tool can provide a navigable and interactive three-dimensional visualization of the product configuration. Once the design of the product configuration is complete, sales implementation information can be generated for the custom product. The sales implementation information can include, for instance, a specification, a bill of materials, engineering drawings for the product, a quote for fabrication and delivery of the product, and other information. On approval of the quote, the product can be ordered. The time from initiation of the customization to placing the order may be no more than a few minutes.

### PRIORITY CLAIM

This application claims the benefit of priority of U.S. Provisional Patent Application Ser. No. 61/674,612 entitled “Visual Scaling Engine for Customization of Products,” filed Jul. 23, 2012, which is incorporated herein by reference for all purposes.

### FIELD

The present disclosure relates generally to computer assisted customization of products, and more particularly to a computer-implemented tool for the creation and design of custom products in real time that provides sales implementation functionality.

### BACKGROUND

Conventional product drawing and rendering tools provide for the customization and development of products by trained users to meet specifications. Certain of these tools provide additional functionality, such as the ability to provide quotes and bills of material based on the custom designed products. However, these drawing and rendering tools typically include complex layers of user interaction and visual design tools. While such tools are powerful and can provide increased design functionality, the complexity of tools and layers can be overwhelming to users and can require extensive training for a user to become competent in the design tool. Moreover, it can be difficult to quickly generate custom designs in response to product demands, such as during a sales call, using the complex design tools.

Simple design interfaces for customizing products exist. For instance, various online tools provide for the user-customization of products. These design tools, however, typically do not contemplate a complete functional and scalable design of one or more custom products, or the relationship or interdependencies of such custom products. These design tools also do not include all necessary information to quickly generate sales implementation information, such as quotes, bills of material, engineering specifications, product orders, etc.

Thus, a need exists for a configurator tool that provides an intuitive and simple design tool interface that can be used quickly and collaboratively to design and customize products, and to establish their relationship, relative scales, and interdependencies. A tool that can provide sales implementation functionality, such as the ability to quote, order, and track the customized products through production and delivery, would be particularly useful.

### SUMMARY

Aspects and advantages of the invention will be set forth in part in the following description, or may be obvious from the description, or may be learned through practice of the invention.

One exemplary aspect of the present disclosure is directed to a computer-implemented method of generating a product configuration. The method includes presenting a visual design tool on the display of a computing device. The visual design tool provides a user interface capable of presenting a three-dimensional visualization of the product configuration. The visual design tool is configured to provide affordance-based construction of the product configuration. The method further includes receiving a first user input generating at least one component of the three-dimensional product configuration in the visual design tool. In response to the first user input, the method includes rendering the at least one component in conjunction with an affordance proximate to the at least one component as part of the three-dimensional visualization. The affordance suggests one or more design modification capabilities to the user. The method further includes receiving a second user input directed to the affordance and modifying the three-dimensional product configuration in response to the second user input directed to the affordance. The method further includes generating, with the computing device, sales implementation information (e.g. quotes, bills of materials, product orders, etc.) based on the product configuration.

Other exemplary aspects of the present disclosure are directed to systems, apparatus, non-transitory computer-readable media, user interfaces and computing devices for generating a product configuration and providing sales implementation information based on the product configuration.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a flow diagram of an exemplary method for generating a three-dimensional product configuration according to an exemplary embodiment of the present disclosure;

FIGS. 2-11 depict exemplary user interfaces of a design tool configured to provide affordance-based construction of a three-dimensional product configuration according to an exemplary embodiment of the present disclosure;

FIGS. 12 and 13 depict exemplary isolation views of a component of a product configuration presented by a design tool according to an exemplary embodiment of the present disclosure

FIG. 14 provides a flow diagram of an exemplary method for generating sales implementation information according to an exemplary embodiment of the present disclosure;

FIG. 15A depicts an exemplary request for a quote generated for the completed product configuration shown in FIG. 5 according to an exemplary embodiment of the present disclosure;

FIGS.15B-15D depict an exemplary quote generated for the completed product configuration shown in FIG. 5 according to an exemplary embodiment of the present disclosure; and

FIG. 16 provides a block diagram of an exemplary computer-based system for generating a product configuration according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

Generally, the present disclosure is directed to computer-based systems and methods for implementing a configurator tool that provides for the creation and design of custom products in real time and that includes sales implementation functionality. As used herein, a “product” refers to any object capable of manufacture, including, but not limited to, a range of products from industrial products to consumer products. According to aspects of the present disclosure, a visual design tool can provide a user the capability to configure in real time a three-dimensional product configuration. The product configuration can be an arrangement of a group of components to form the product. The product configuration provides the design of the product. The visual design tool can provide a navigable and interactive three-dimensional visualization (i.e. a graphic three-dimensional representation) of the product configuration. The product can be designed from a plurality of pre-existing components using affordance-based construction techniques. The three-dimensional visualization of the product can be completely scalable and can be viewed from any perspective. For instance, the visualization of the product can be zoomed, rotated, tilted, enlarged, etc. while presenting an accurate three-dimensional visualization of the product configuration.

Furthermore, as soon as a purchaser acknowledges that the product configuration meets requirements, sales implementation information can be generated for the custom product. Sales implementation information can be any information that can be generated in conjunction with or to assist the sale, order, manufacture, and delivery of the product. The sales implementation information can include, for instance, a specification, a bill of materials, engineering drawings for the product, a quote for fabrication and delivery of the product, and other information, as well as associated meta-data (e.g. create and modification time stamps, associations between related information, documents, and activities). When the quote is accepted, a purchase order for the product according to the specification can be generated. Information associated with the product can then be tracked through manufacturing and delivery.

The configurator tool according to aspects of the present disclosure can include significant improvements relative to known configurator systems. The visual design tool can provide for the intuitive and simple customization of products using gestural, affordance-based construction techniques. In particular, affordances can be rendered in the three-dimensional visualization of the product configuration, such as overlaying the components of the product configuration. The affordances can be used to guide an untrained and unsophisticated user through the visual design process. The affordances can be rendered in the form of intuitive graphics that enable and subsequently encourage gestural interaction with the affordances by the user. The affordances can be used to provide direct and intuitive access to various functions, such as, for instance, adding additional components to the product configuration, deleting components from the product configuration and/or scaling the three-dimensional product configuration or components thereof in any or all three dimensions to meet purchaser requirements.

The configurator tool according to aspects of the present disclosure can further include a rules engine. The rules engine can be configured to analyze the three-dimensional design configuration and any modifications relative to one or more sets of rules, such as engineering rules, safety rules, code requirements, etc. The rules engine can provide visual and textual alerts when the three-dimensional design configuration does not conform to the one or more sets of rules. The alerts can be affordance-based to encourage user interaction with the alert to modify the design to conform to the one or more sets of rules. The rules engine can also provide hidden constraints so that the user cannot exceed the predefined engineering rules or capacities of a product configuration. In addition, the rules engine can automatically modify or generate the three-dimensional product configuration such that the product design satisfies the one or more sets of rules. For example, if a change in the scale of a component of the design requires a change to the configuration for safety or for reasons of strength, these changes can be made to the design automatically. Components can also be added to the product configuration to provide safety or needed strength.

The configurator tool according to aspects of the present disclosure can be implemented on any suitable computing device that includes a display for visualization of the three-dimensional product configuration, such as a desktop, laptop, mobile device, smartphone, PDA, tablet, or other suitable machine capable of performing computations automatically. The display can be well suited for graphic displays and the computing device can have the requisite memory and processing speed to present graphic images. In one implementation, the computing device can include a touch interface, such as a touch screen, that responds to touch gestures by a user. The touch gestures can include any suitable gesture, such as tapping, double tapping, flicking, dragging, pinching open, pinching closed, touching and holding, two-finger scrolling, and other suitable techniques. The use of gestures in combination with the affordance-based construction techniques disclosed herein can provide for the user intuitive design of three-dimensional products in real time (such as during a sales call) without requiring extensive training or other assistance.

The present disclosure will be discussed with reference to touch gestures for exemplary purposes. Other suitable gesture interactions can be used without deviating from the scope of the present disclosure. For instance, motion-based gestures performed using simple motion of a user can be used to interact with the configurator tool. The motion-based gestures can be implemented using any suitable technology, such as camera technology, RFID technology, optical technology, or other suitable motion-based gesture recognition technology.

In one example, the configurator tool can be used to design a product that meets a purchaser's particular needs. The product can be a pre-existing product that must be customized for a particular use. For instance, the product can be a configurable product made of a plurality of pre-existing components selected and combined to configure the product the purchaser requires.

The user can be the seller of the product (or any of the seller's sales representatives). The user can confer with the purchaser and, due to the simple and intuitive characteristics of the tool, either the user or the purchaser can configure the product with purchaser input by configuring in real time a visualization of the product using the visualization engine. The user can select and combine visualized components by manipulating the visualizations of the components and can manipulate the visualization of the product configuration to ascertain whether the product configuration meets the needs of the purchaser.

The purchaser can view from any angle the visualized product in a user interface presented on the display of the computing device. Indeed, the design tool may also present a photographic or artistic image in the form of a virtual diorama so the configured product appears in the context of a background suggestive of the environment of use of the product. Other visualized objects and products can be overlaid within the three-dimensional representation so that their scale and interactions can be observed and the scale of the particular product of interest can be adjusted accordingly. This capability assists in the design process because it can reveal design issues, particularly interferences between and among different structures. Once the product configuration is approved, the configurator tool can provide sales implementation functionality to guide the sales process for the product configuration.

The configurator tool can provide for a streamlined design and sales process for a variety of configurable products. For instance, via the configurator tool, the time from initiation of the design process to the placing of the order may only be a few minutes, which can cut delivery time of the manufactured product by weeks or months. This time and the associated costs savings are made possible by the simple and intuitive affordance-based construction of the design tool which enables the previously disassociated design function to be embedded, collaboratively in real time, within a new sales design process. This new sales design process allows information to be collected and organized from each customer interaction for more effective management of product sales, inventory, and manufacture.

In creating and managing configurations of products, the subject matter of the present disclosure avoids complex computer assisted design (CAD) in favor of a user interface that presents components in three dimensions and in color, and allows manipulation of the visualizations to enable the user to see details and the interfaces of components. The use of three-dimensional visualizations of the components can greatly improve the user's and the purchaser's experience and can allow more rapid and successful design in the final product configuration. The ability of the user to present a realistic demonstration of a product and to design it with the customer at the same time, for instance during a sales call, increases productivity by reducing the time between product presentation and product delivery.

### Flow Diagram of an Exemplary Method for Generating a Product Configuration

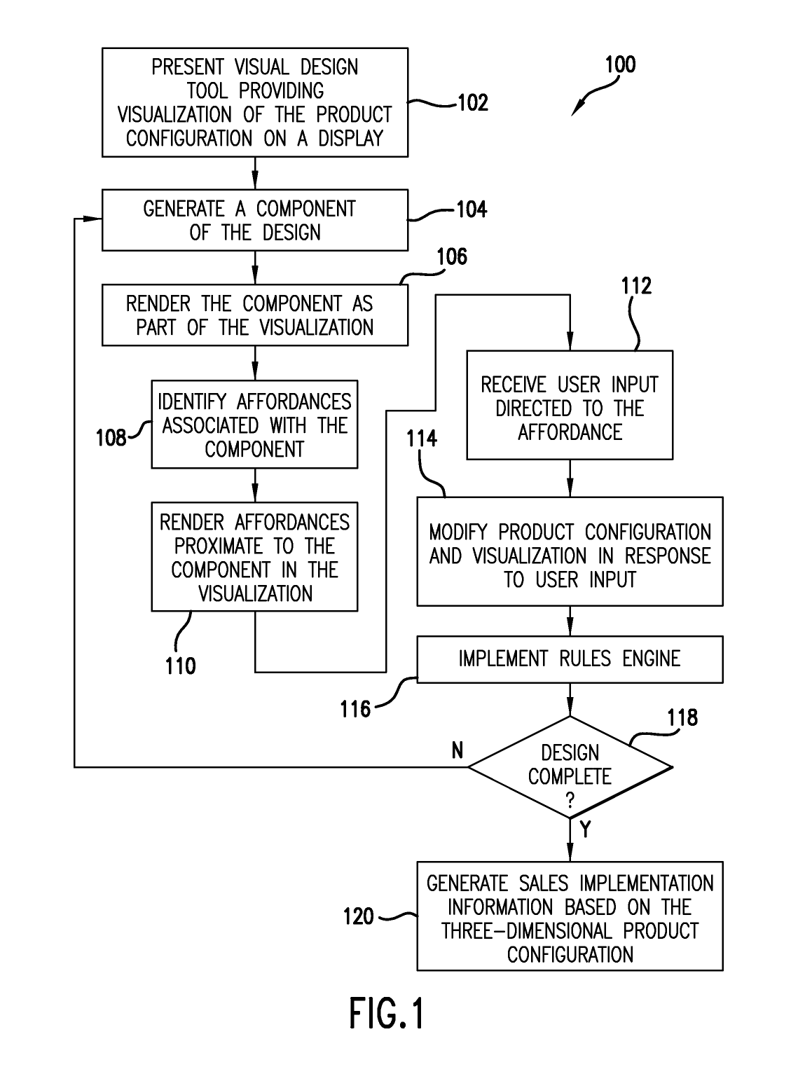

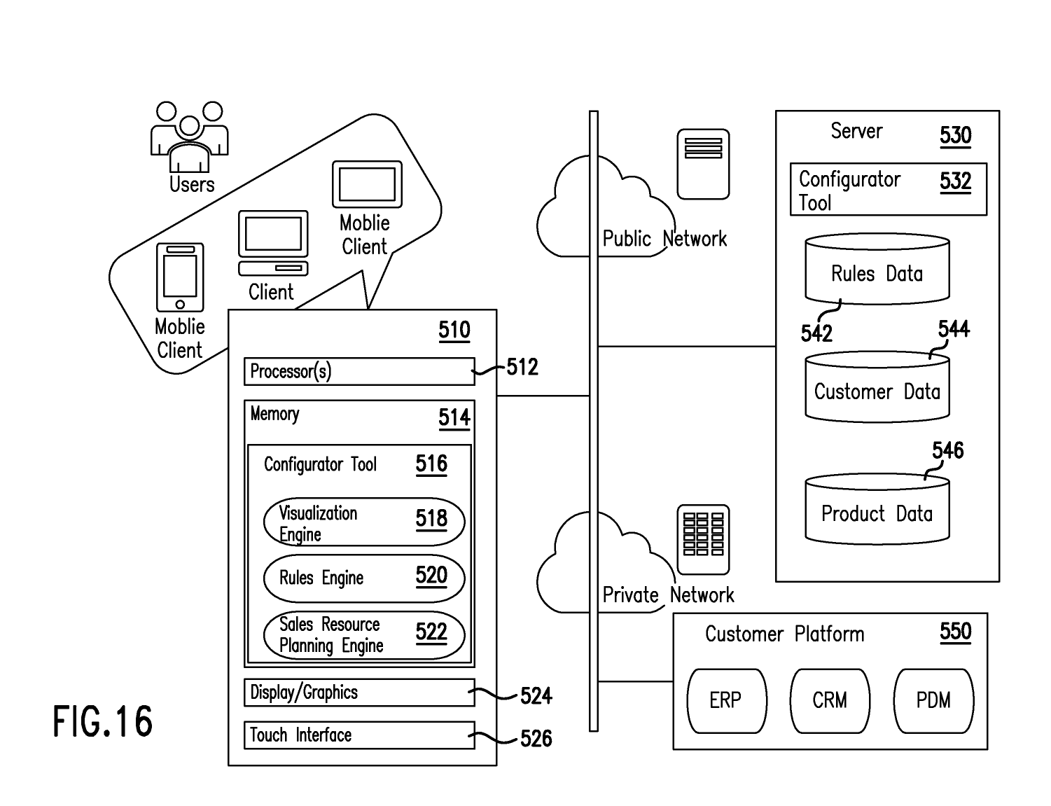

Referring now to the FIGS., exemplary aspects of the present disclosure will now be discussed in detail. FIG. 1 depicts a flow diagram of an exemplary method (100) of generating a product configuration according to an exemplary embodiment of the present disclosure. The method (100) can be implemented using any suitable computing system or device, such as the system depicted in FIG. 16. FIG. 1 depicts steps performed in a particular order for purposes of illustration and discussion. Those of ordinary skill in the art, using the disclosures provided herein, will understand that the various steps of any of the methods discussed herein can be adapted, omitted, and/or rearranged in various ways.

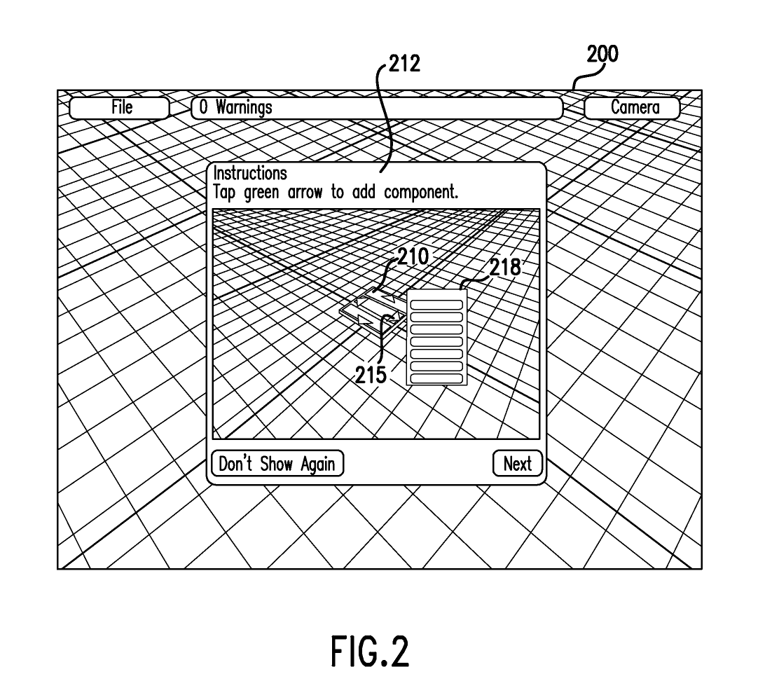

At (102), a visual design tool is presented on a display of a computing device. The visual design tool can provide a user interface capable of presenting a three-dimensional visualization of the product configuration. The three-dimensional visualization provides a perspective three-dimensional view or rendering of the product configuration in a three-dimensional space depicted on a two-dimensional display of the computing device. The user interface can provide the user the capability to view the three-dimensional visualization of the product configuration from a variety of different perspectives. For instance, the user interface can provide various navigation controls and or gesture-based affordances that can allow a user to navigate, pan, tilt, or zoom the three-dimensional visualization of the product configuration. An exemplary user interface 200 depicting a visualization of a product configuration for is depicted in FIGS. 2-11.

According to aspects of the present disclosure, the visual design tool can provide for the real time manipulation, modification, and construction of the components to generate the product configuration using affordance-based construction techniques. Affordance-based construction refers to the use of one or more affordances that suggest to a user one or more design modification capabilities to construct the product configuration. As used herein, an affordance can include one or more visual or graphic controls presented in a user interface that suggest to the user various design modification capabilities in constructing the product configuration. The affordances can be gesture-based such that they are responsive to a user interaction, such as a touch gesture.

In a particular implementation, the visual design tool can provide a virtual diorama in conjunction with the three-dimensional visualization. The virtual diorama can provide a background suggestive of an environment of use for the three-dimensional product configuration. The virtual diorama can be generated from a photograph or other image. In one example, the virtual diorama can be generated from an image captured using an image capture device (e.g. a digital camera). The image capture device can be a part of the computing device, such as a smartphone or tablet, implementing the visual design tool. This allows the user to capture a particular background image for the product, for instance, during a sales call. The user can build and design the product configuration using the visual design tool relative to the background image. The visual design tool can also provide gridlines as a background so that the orientation and perspective of the visualized product is readily apparent.

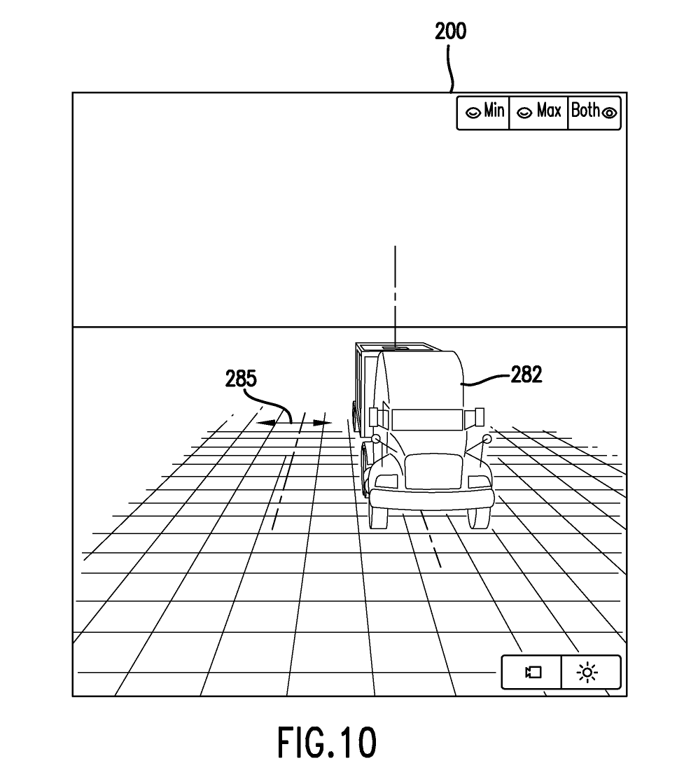

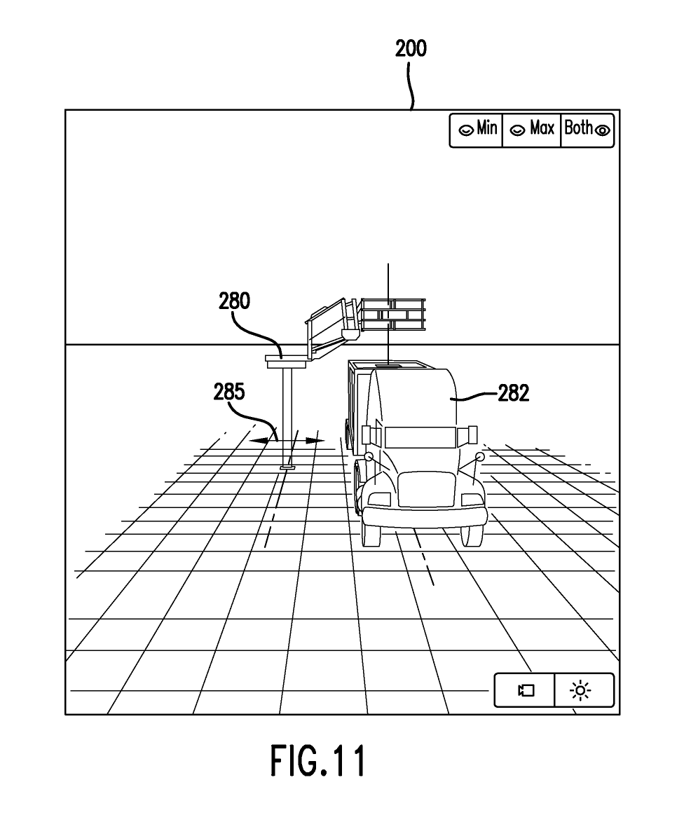

At (104), at least one component of the three dimensional product configuration is generated. Each component generated for the product configuration can have an associated data object. The data object can specify characteristics of the component that can be used by the visual design tool to provide a visualization of the component. The data object can specify attributes (e.g. size, color, etc.) associated with the component. The attributes of the component can be modified during the design process. For instance, in a particular implementation, a user can request an isolation view of the component. The isolation view can provide an interface for modifying one or more attributes of the at least one component. The isolation view can provide a user intuitive carousel interface for modifying the one or more attributes. Exemplary isolation views associated with a component will be discussed with reference to FIGS. 10 and 11 below.

The data object associated with each component can specify both characteristics of the component used to render a visualization of the component (e.g. dimensions, location, color, shape, etc.) and characteristics that can be analyzed to generate sales implementation information, such as quotes, product specifications, engineering drawings, bills of materials, purchase orders, etc. In one particular implementation, the visual design tool accesses data objects limited to data sufficient to view the component as a three-dimensional object and, when appropriate, its movement in the three-dimensional visualization. By limiting the properties of the data objects, the manipulation of the data objects for that component or product can be accomplished more quickly and with less computer memory, and preferably by touch gestures, than if all of the properties remained associated with the data object. The full ranges of properties of the components can be available in a database, such as a database associated with a remote server that is accessible over a network.

The component can be generated in response to a user input. For example, in one embodiment, each product configuration can start with the same basic component. The basic component can be automatically generated during the start or initiation of a new product configuration. As another example, the user can select the component from a library of pre-defined components associated with the product configurations. For instance, the visual design tool can be tailored for a particular manufacturer by generating a library of pre-defined components used to construct the particular product produced by the manufacturer. A user can generate a component of the product configuration by providing a user input selecting one of the pre-defined components from the library to be included in the product configuration. Alternatively, the user can build or construct a new component from scratch using various drawing and attribute specification tools provided by the visual design tool.

Once the component of the product configuration has been generated, the component is rendered as part of the visualization of the product configuration (106). The user can view the product component from many different perspectives in the design tool. At (108), affordances associated with the component are identified. For instance, a database of affordances can be accessed to determine which affordances to present in conjunction with the component. The affordances can be directly associated with the particular component or the affordances can be linked with the component, for example, based on component type For example, a scaling affordance can be presented with any scalable component. As another example, an affordance that provides a guide for attaching additional components can be provided in association with all components of the product configuration.

After identifying the affordances associated with the component, the method includes at (110) rendering the affordances proximate to the component in the visualization. As used herein, an affordance is proximate to a component in the visualization if the affordance at least partially overlays or overlaps the component and/or if the affordance occupies a space defined by the external boundaries of the component. The affordances can be represented as any suitable graphic. For instance, the affordances can include arrows, “X”s, icons, or other suitable graphics. The affordances can suggest one or more design modification capabilities to a user. For instance, an arrow affordance can be used to suggest that additional components can be added or attached to the component at a location signified by the arrow affordance. An arrow affordance can also be used to suggest that the component can be scaled in the direction indicated by the arrow affordance. An “X” affordance can indicate that a particular component can be deleted. Other suitable affordances can be used without deviating from the scope of the present disclosure.

At (112), a user input directed to the affordance is received. For instance, the user can provide a touch gesture (e.g. tap, double tap, etc.) directed to the affordance. The product configuration and associated visualization can be modified in response to the user input (114). For instance, depending on the type of affordance, new components can be added to the product configuration, the product configuration can be scaled, components can be scaled, products can be deleted or removed from the product configuration, etc. The visualization is modified in conjunction with the product configuration such that the user can assess the visualization of the product configuration as it is being constructed.

At (116), a rules engine is implemented to check whether the modified product configuration conforms to one or more sets of rules, such as engineering rules, safety rules, code requirements, etc. For instance, the visual design tool can access the one or more sets of rules stored in a rules database. In one embodiment, the rules database can be a remote database that is accessible by the visual design tool, for instance, over a network. Alternatively, the rules database can be stored on the computing device implementing the visual design tool.

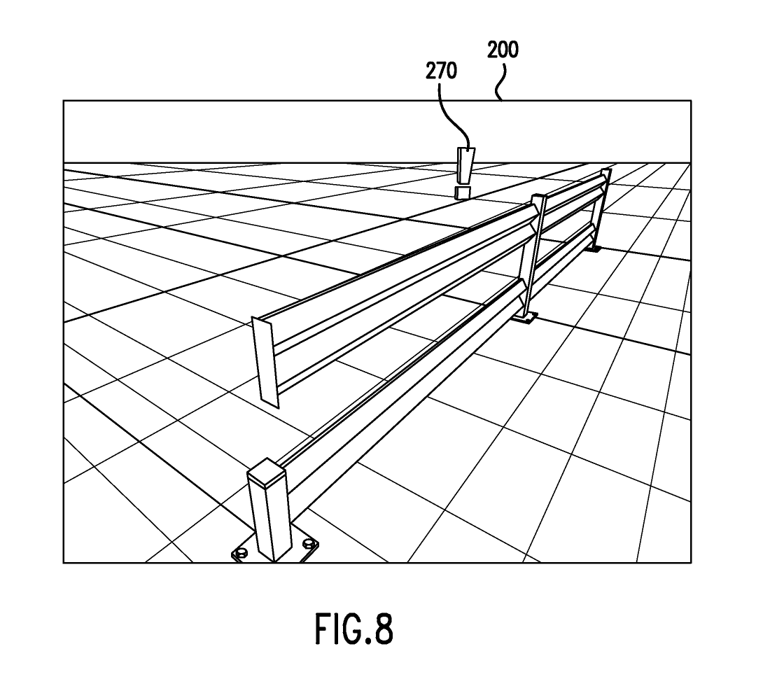

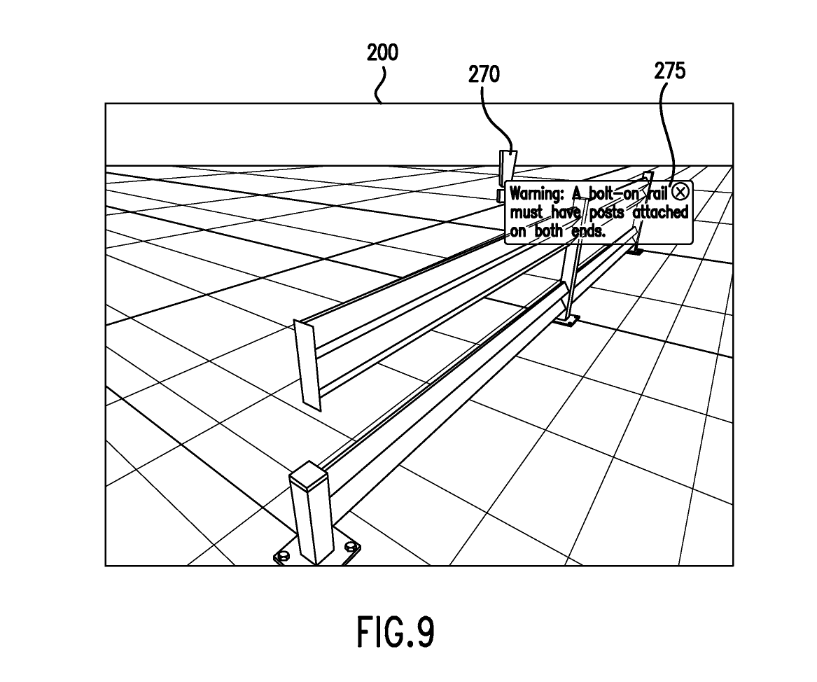

The rules engine can analyze the three-dimensional design configuration for compliance with the one or more sets of rules. For instance, the rules engine can assess the product design configuration to determine if the product configuration satisfies conditions specified by the one or more rules. If the conditions are not satisfied, the rules engine can provide an alert or warning to the user indicating that one or more conditions are not satisfied. The alert can be provided in any suitable format. For instance, the alert can be provided as a visual, audio, vibratory, or other alert. Exemplary visual alerts are depicted in FIGS. 8 and 9 discussed below.

The rules engine can also be configured to modify the product configuration such that the product configuration conforms to the one or more sets of rules if the rules engine determines that the conditions are not satisfied. As one example, if it is determined that extra supports are needed due to scaling of the product configuration, the rules engine can automatically add the required extra supports to the product configuration. In this way, a user can easily construct a complete, accurate, and functional product configuration without having to remember to add all necessary components to comply with various engineering rules, safety rules, code requirements, and other rules.

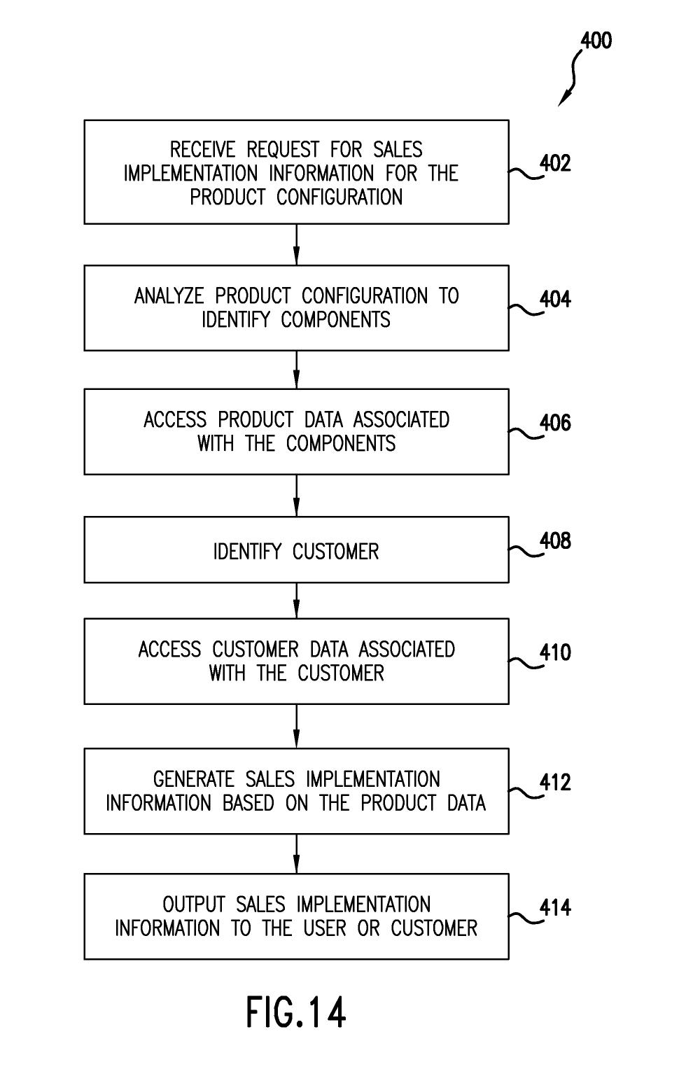

At (118), it is determined whether the design of the product configuration is complete. For instance, it can be determined whether a user has provided a suitable input indicating that the product configuration is complete and has been accepted. If the design of the product configuration is not complete, the method can return to (104) where more components can be generated for the product configuration. The affordance-based construction of the product configuration using the visual design tool can continue until the design of the product configuration is complete. Once the design has been completed, sales implementation information can be generated based on the product configuration (120). A flow diagram exemplary method for generating sales implementation information based on the product configuration will be discussed with reference to FIG. 14.

### Example Affordance-Based Construction of Product Configuration

To better illustrate aspects of the present disclosure, an example demonstrating exemplary affordance-based construction of a product configuration using a visual design tool according to aspects of the present disclosure will now be presented in conjunction with FIGS. 2-11. The present example will be discussed with reference to constructing a product configuration associated with elevated walkways and platforms for exemplary purposes. Those of ordinary skill in the art, using the disclosures provided herein, will understand that the particular examples provided herein are in not limiting of the present disclosure. Rather the subject matter of the present disclosure can be adapted to be used with any product assembled of components that can be arranged in various configurations to meet the individual requirements of purchasers. In addition, the example depicted in FIGS. 2-9 provides an exemplary subset of the affordance-based construction capabilities of the present disclosure.

A user can initiate the product design by providing an appropriate user input to the visual design tool. The visual design tool can generate and provide a visualization of a basic component. In the example shown in FIG. 2, the basic component is a platform 210. As shown, the platform 210 is rendered with a plurality of affordances 215. The affordances 215 are rendered overlaying the platform 210 so that the user's attention is drawn to the affordances 215. The affordances 315 suggest a design modification capability to the user, namely the ability to add additional components 210 to the platform. Text instructions 212 can be rendered in conjunction with the affordances 215 to provide further information regarding design modification capabilities to the user.

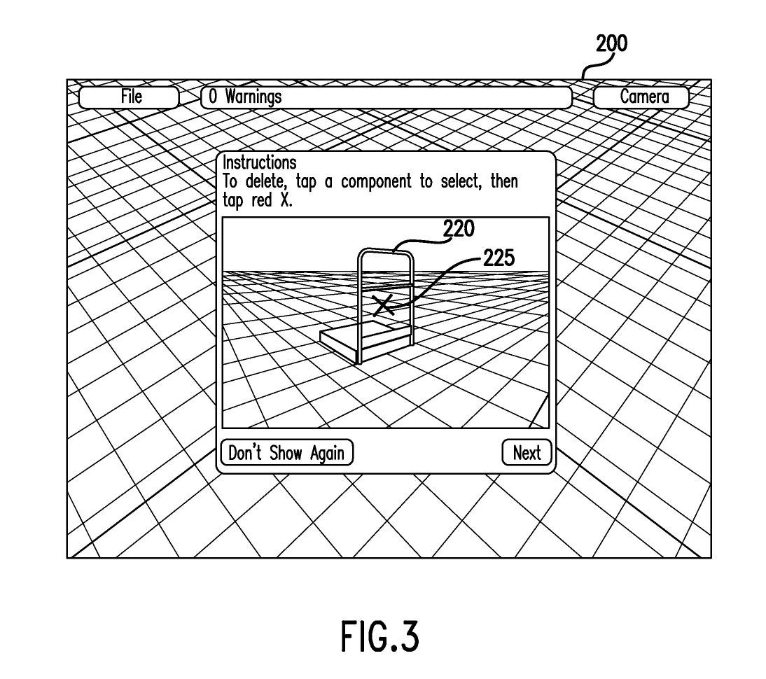

The affordances 215 of FIG. 2 in the form of green arrows. The green arrows can provide a guide for attaching one or more additional components to the platform 210 at the location signified by the arrows. To add a component to the platform 210, such as the handrail 220 shown in FIG. 3, the user looks for and interacts with the affordance 215 shown on the basic component as a guide for where components may be attached. For instance, the user can provide a touch gesture directed to the affordance 215.

In response to the interaction, a set of components 218 is shown that can be added to the platform at the location of the arrow. The system highlights components in the set 218 that can be added at that location while other components that cannot be added at that location are not highlighted. In the example of FIG. 2 where the component is a platform 210, a rail, a stair, or a support of the right size will be highlighted and can then be added by suitable user input. The user can then add other components to the platform 210 by interacting with other affordances 215 rendered in conjunction with the platform 210. To facilitate the design process, multiple components can be added at one time to those locations where they can or should be added, based on engineering rules. For example, by selecting functions such as “extras” or “auto-handrail,” handrails can automatically be added to every open side of the platform.

When adding a component to the product configuration, the visual design tool can automatically determine the dimensions of the added component that will fit based on the properties (e.g. dimensions) associated with the existing components. For example, the visual design tool can accumulate dimensions with respect to a starting point so that it can build and display the dimensions of the product being configured. For example, a customer adds a stair component to the platform 210 such that the platform 210 is 30″ relative to the ground. If the customer the customer wants to add a tower to support an opposing side of the platform, the configurator automatically determines that the tower needs to be a 30″ tall tower so that the platform component 210 is level with respect to the ground. The 30″ tower can be automatically added to the product configuration. The configurator tool can perform other auto-dimensioning functions based on parameters of components of the product configuration.

FIG. 3 depicts a visualization of the product configuration after adding handrail 220 to the platform 210. Affordances can be provided for the deletion or removal of components from the product configuration. For instance, to remove a component, a user can interact with the component causing an affordance to appear in conjunction with the component. In FIG. 3, an affordance 225 in the form of a red “X” is rendered in the space defined by the external boundaries of the handrail 220. The affordance 225 suggests to the user that the user can delete the component by interacting with the affordance 225.

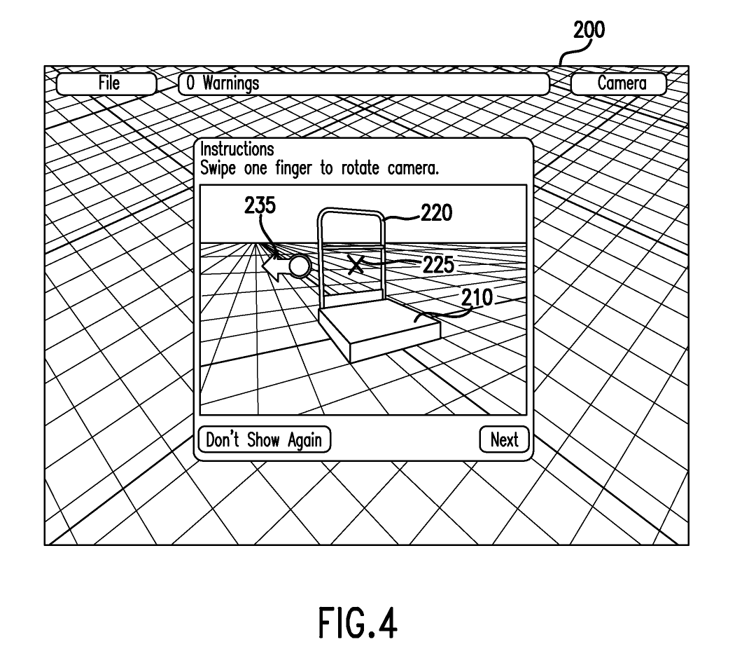

FIG. 4 illustrates that the three-dimensional visualization of the product configuration can be rotated. In particular, an affordance 235 can be presented in conjunction with the product configuration. The affordance 235 can be in the form of a circle with an arrow suggesting to a user that the visualization of the product configuration can be rotated relative to its background environment. Upon user interaction with the affordance 235, the visualization can be rotated to provide a different view of the platform 210 and handrail 220 (including affordance 225) to the user.

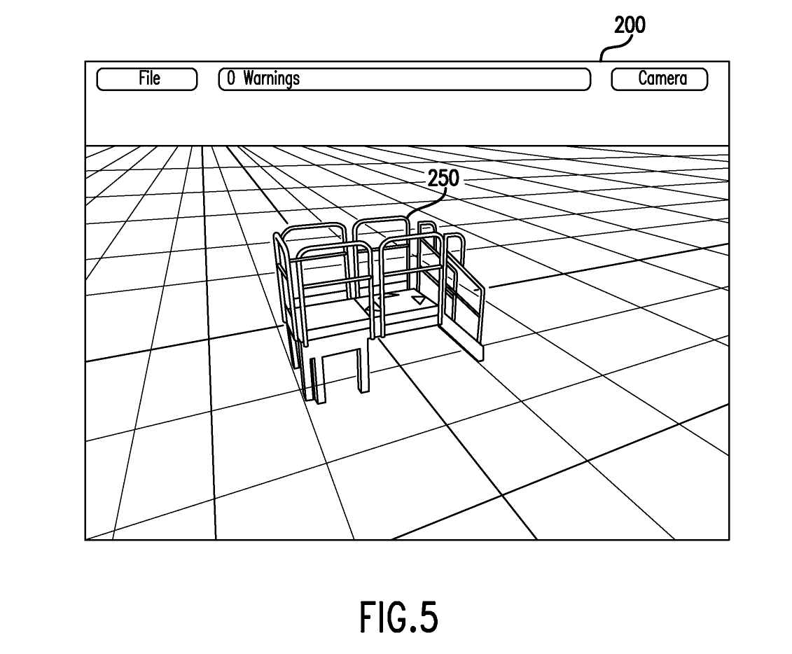

FIG. 5 depicts an exemplary visualization of a complete product configuration 250 generated according to aspects of the present disclosure. After the design of the product configuration is completed, the configurator tool can be configured to implement a sales implementation engine to generate sales implementation information, such as quotes, based on the three-dimensional product configuration.

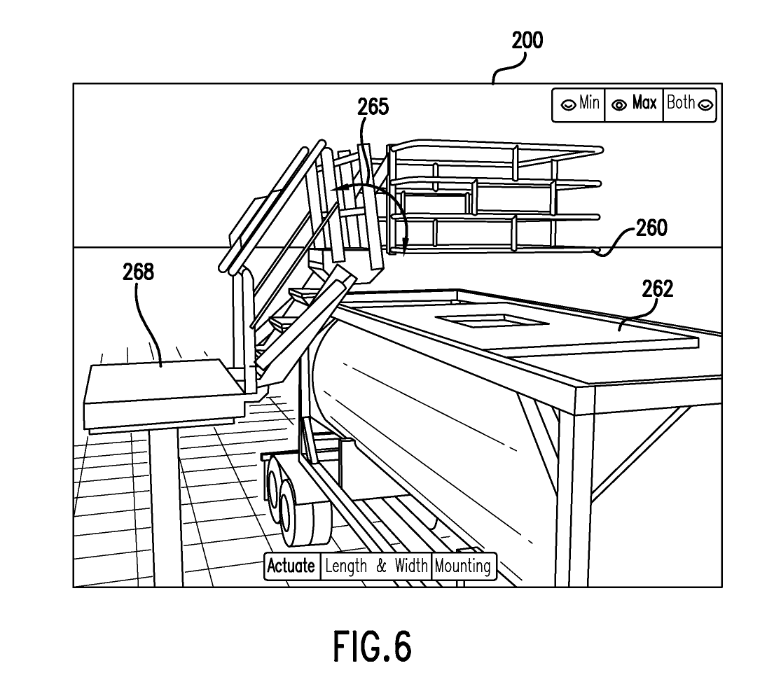

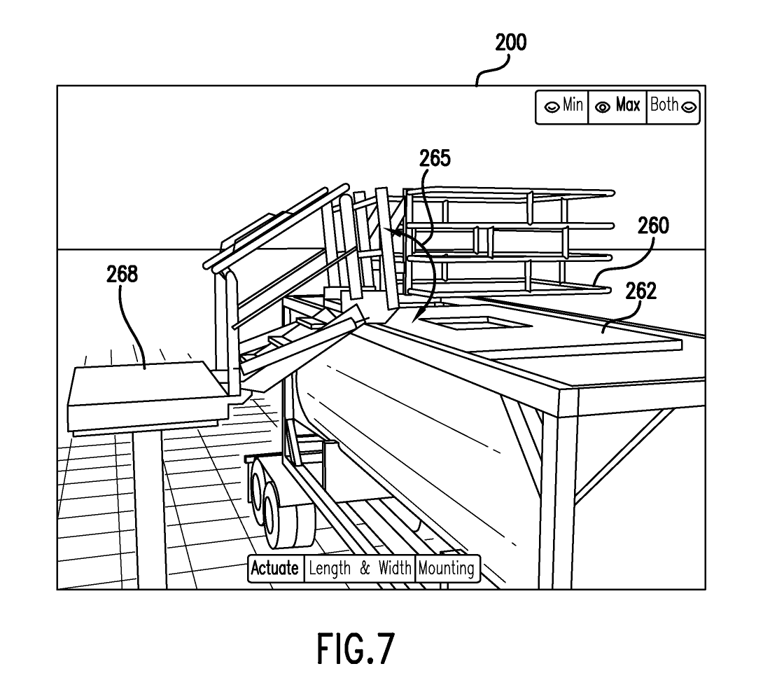

FIGS. 6 and 7 depict another exemplary affordance-based construction capability, namely the ability to rotate components relative to one another in the product configuration. For instance, FIGS. 6 and 7 depict the ability to rotate component 260 relative to components 262 and 262. As shown in FIG. 6, an affordance 265 can be rendered in conjunction with the product configuration. The affordance 265 is a curved arrow that suggests to the user that component 260 can be rotated about an axis signified by the affordance 265 relative to components 262 and 268. FIG. 7 depicts the product configuration after the user has interacted with the affordance, using for instance a touch gesture, to rotate the component 260 relative to components 262 and 268.

To prevent a configuration that is inappropriate and also to enable a configuration that is appropriate, a rules engine can govern the selection and properties of all choices so that product configuration meets engineering guidelines, safety guidelines, code requirements, etc. Warnings or alerts can also appear, for instance in the visualization or on a generated quote, where choices are questionable.

FIGS. 8 and 9 depict exemplary visual alerts that can be provided by the rules engine to prevent a configuration that is inappropriate. As shown in FIG. 8, an affordance 270 in the form of an exclamation point can be presented to the user. The affordance 270 can provide an alert to the user that the product configuration does not meet certain specified rules. A user can interact with the affordance 270, for instance, using a touch gesture and/or other suitable gesture. In response to the user interaction, text 275 can be displayed to the user to inform the user of condition for providing the alert. In addition or in the alternative, the product configuration can be automatically modified to conform to the required rules. For instance, in the example product configuration of FIG. 9, a post component with appropriate dimensions can be added to the product configuration so that a bolt-on rail has posts attached on both ends.

FIGS. 10 and 11 depict an example of the rules engine enabling an appropriate configuration to meet engineering rules. In particular, upon user interaction with affordance 285 shown in FIG. 10, a platform can be automatically fitted and/or scaled relative to its intended background, in this example the truck 282. In particular, the rules engine can automatically configure attributes of the product configuration such that the product configuration meets specified rules.

FIG. 11 shows how the platform 280 can be automatically dimensioned and arranged in response to an interaction with affordance 285 such that the platform 280 is properly centered over the truck 282 and such that appropriate clearances are provided between the platform 280 and the truck 282. Further interaction with the affordance 285 can modify the configuration and arrangement of the platform 280 relative to the truck 282. For instance, the base of the platform 282 can be moved further away from the truck 282 while maintaining at least a portion of the platform 280 over the center of the truck 282.

### Exemplary Isolation View for Modifying Attributes of a Component

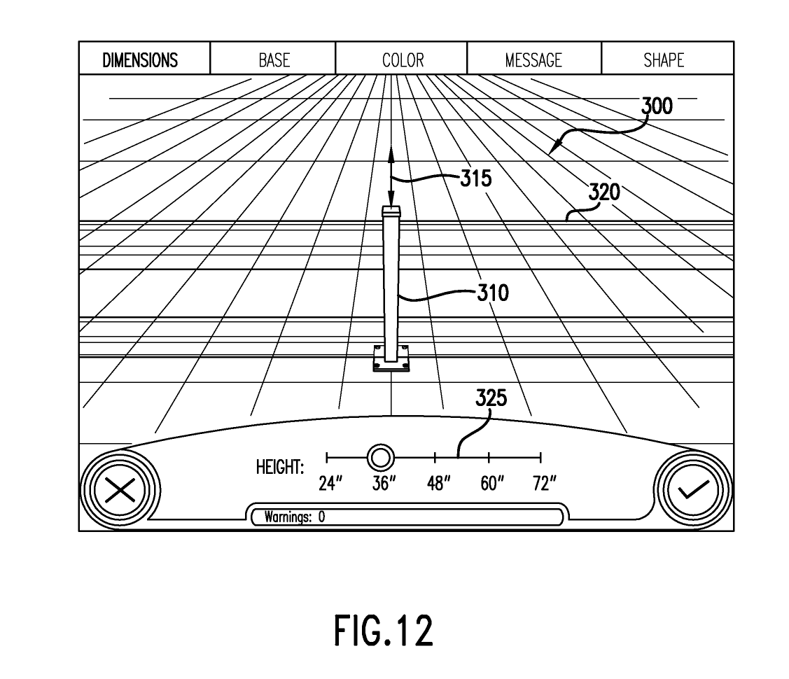

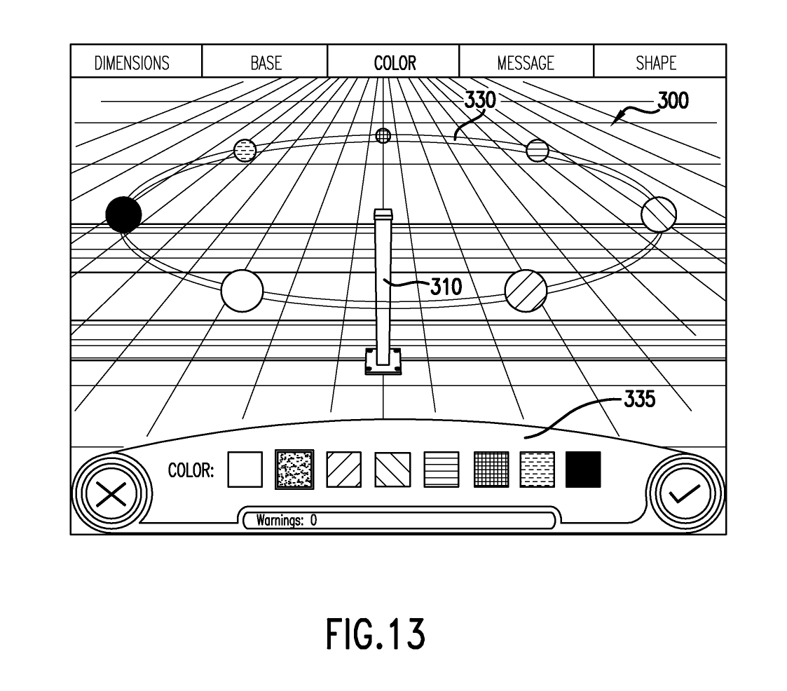

FIGS. 12 and 13 depict an exemplary isolation view for modifying attributes of a component during construction of a product configuration according to an exemplary aspect of the present disclosure. A user can request an isolation view of a particular component by providing a suitable user input, such as a interacting with an icon using a touch gesture. The isolation view can realign the view of the product configuration to get a better view of the selected component. The rest of the components of the product configuration can be faded out. For instance, as shown in FIG. 12, the isolation view 300 provides an aligned view of the component 310 and has faded out components 320 in the isolation view 300.

The isolation view can provide an interface for modifying attributes of the component. In FIG.12, the isolation view 300 provides an interface for modifying the height of the component 310. The interface can include an affordance 315. The affordance 315 can suggest that the user can modify the height of the component 310. A user can modify the height by providing a suitable user input, such as a touch gesture, directed to the affordance 315. The isolation view 300 of FIG. 12 also includes a slider tool 325 for adjusting the height of the component 310.

FIG. 13 depicts an isolation view 300 providing a carousel interface 330 for modifying attributes of the component 310. The carousel interface 330 provides a variety of options (e.g. colors), that can be selected for the component in a ring intersecting the component 310. A user can swipe the carousel interface 330 using a suitable user input, such as a finger swipe touch gesture, to cause the options to rotate relative to the component 310. When a certain option intersects with the component 310, the component 310 changes to provide a preview of the option. The option also disappears from the carousel interface 330. The carousel interface 330 provides a user intuitive interface for modifying attributes of the component 310. Attributes of the component 310 can also be modified using the suitable selection tool 335 presented in conjunction with the isolation view 300.

When a user is finished modifying attributes of the component using the isolation view, the isolation view is closed and the user is returned to the visualization of the product configuration. The three-dimensional visualization can provide a representation of the component showing all the options added to the component during the isolation view.

### Exemplary Flow Diagram for Generating Sales implementation Information

FIG. 14 depicts a flow diagram of an exemplary method (400) for generating sales implementation information based on the product configuration according to an exemplary embodiment of the present disclosure. The method (400) can be implemented using any suitable computing system, such as the computing system depicted in FIG. 16. For instance, the method (400) can be implemented by a sales implementation engine implemented by a processor to generate sales implementation information based on the product configuration.

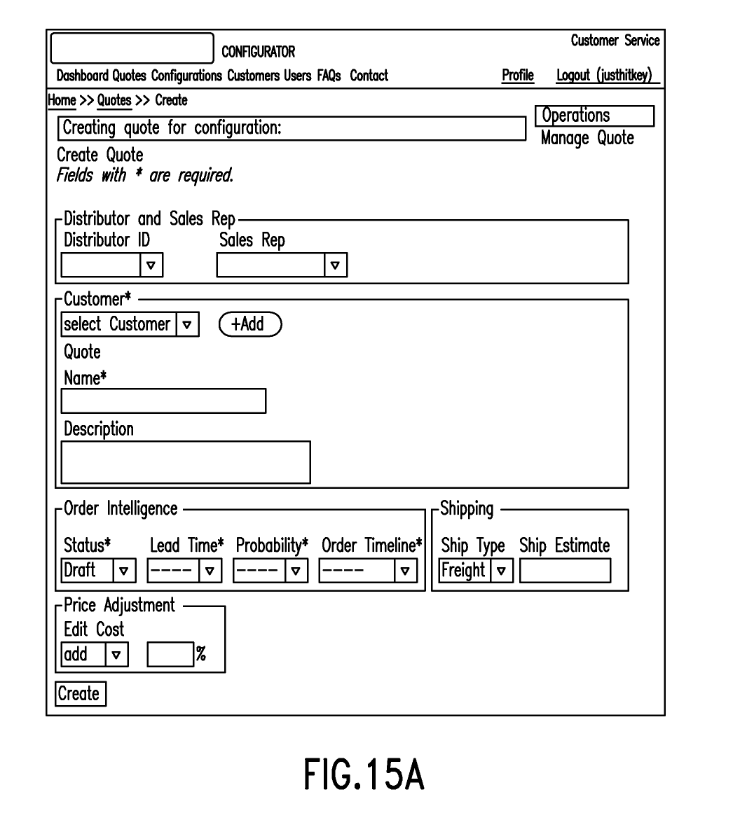

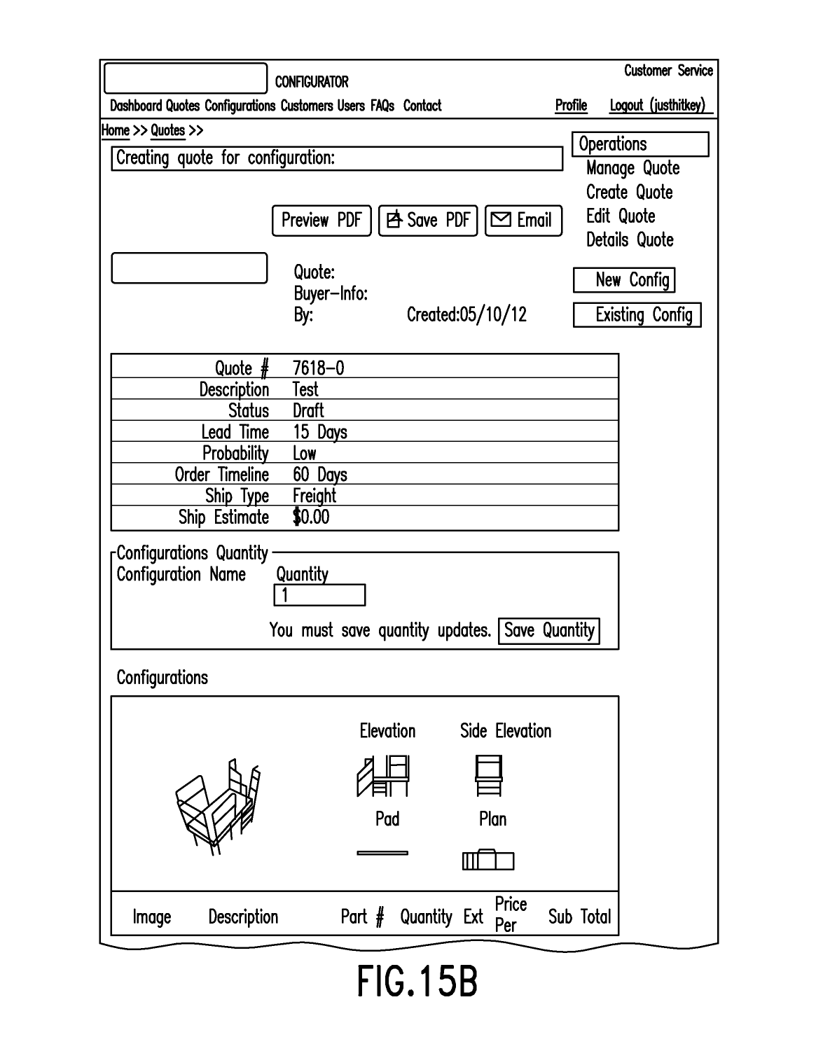

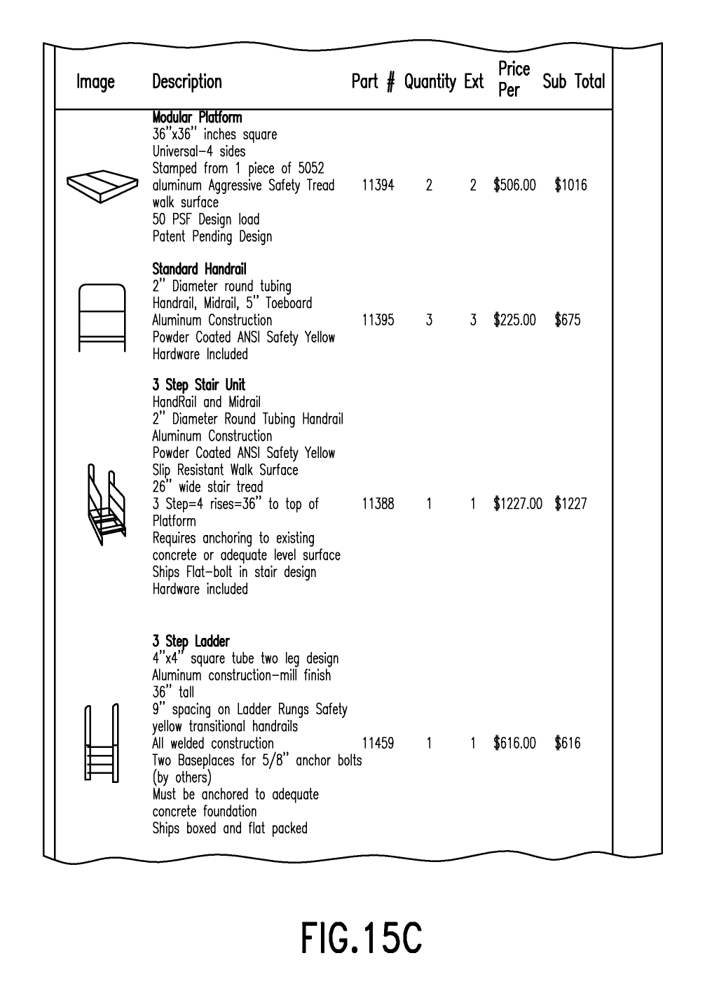

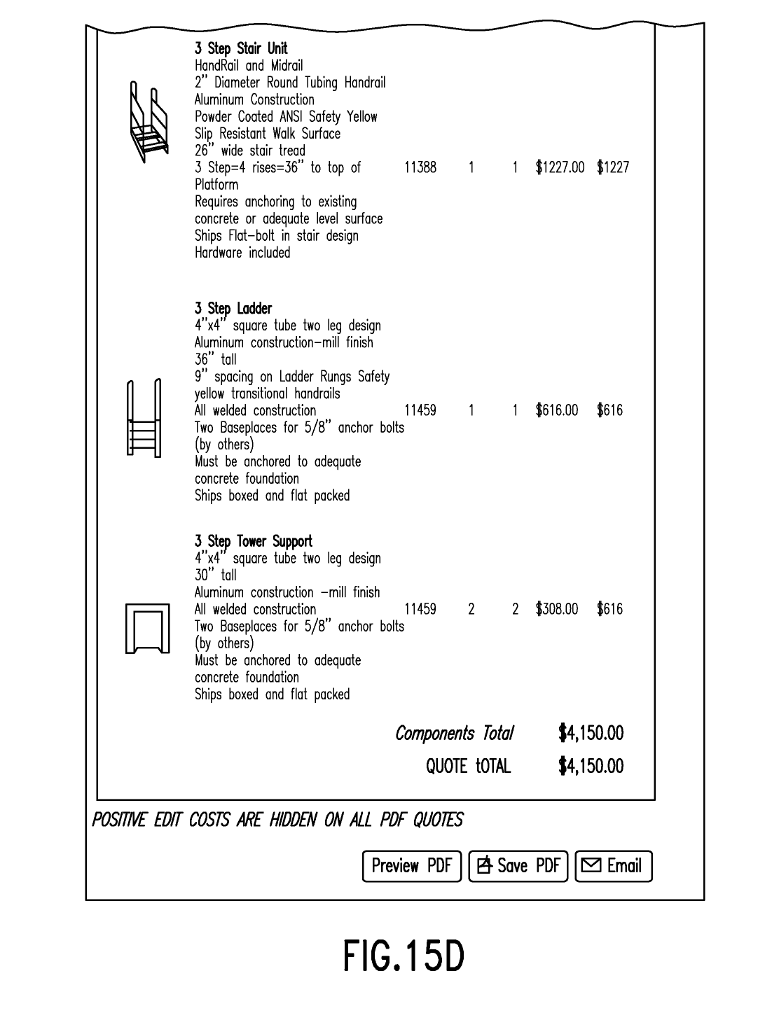

At (402) of FIG. 14, the method includes receiving a request for the sales implementation information. The request can be provided by a user after completing the design of the product configuration. The request can be for one or more different types of sales implementation information, such as for a quote, bill of materials, specification, engineering drawings, purchase order, or the like. An exemplary request for generation of a quote is depicted in FIG. 15A.

Upon receipt of the request, the completed product configuration can be analyzed to identify all of the various components of the product configuration (404). Once identified, product data associated with each of the individual components can be accessed for use in generating the sales implementation information (406). For instance the product data can include, for instance, part numbers, part drawings, inventory information, production information, manufacturing information, cost information, and other information useful in generating sales implementation information. In one particular implementation, the product data can be stored in a product database at a remote server accessible over a network.

At (408), the method can include identifying the customer (e.g. purchaser) for product represented by the product configuration. For instance, the user can manually specify the customer in the request. Alternatively, the customer can be identified automatically. Certain computing devices can have a positioning system (e.g. a GPS system or other suitable positioning system) that can determine the current position of the computing device. If the computing device hosting the configurator tool has such capability, the location of the computing device can be determined and the customer can be identified based on the location of the computing device. This can be particularly beneficial for salespersons using the present configurator tool in the field to provide designs, quotes, and other information for products to customers.

The name of the customer in addition to other customer information about the particular customer that may be available online or stored in a customer information database can be accessed to determine the requisite information automatically. This information may not only be associated with the visualization but used to populate other documentation to be generated, including proposals, engineering drawings, price quotations, brochures and other business records in the customer information database. The customer information database can also include information regarding all of the distributors for each manufacturer, as well as the identity and contact information regarding sales representatives, along with the customers with which their sales representatives are associated. A contact manager tool can be provided that allows the user to store information relevant to each customer, such as contact information, purchasing history, birth date, family information, and other information.

After the customer is identified, customer data stored, for instance, in the customer information database can be accessed (410). Similar to the product database, the customer information database can also be accessed remotely over a network. The customer data can be used in conjunction with the product data to generate the sales implementation information (412). The sales implementation information can then be output to the user or customer (414) as desired.

An example demonstrating the generation of an exemplary quote according to aspects of the present disclosure will now be presented in conjunction with FIGS. 15B-15D. The present example will be discussed with reference to generating a quote for purposes of illustration and discussion. Those of ordinary skill in the art, using the disclosures provided herein, will understand that the particular examples provided herein are in not limiting of the present disclosure.

An exemplary quote generated according to aspects of the present disclosure is depicted in FIGS. 15B through 15D. The quote includes a listing of the required components, a price per component, a total price for building and shipping the parts to the customer, as well as perspective, elevation, and side views of the complete platform system. The quote may include additional information, such as the real-world dimensions of the platform system and indicia and contact information associated with the user.

Generated quotes can be uploaded to a database maintained by the manufacturer. The quotes can be tracked by labeling the quotes with “draft” when created and relabeling the quotes “open” when saved or sent. The user may also change the status of a quote to “Decision”, “Lost”, “Purchased” or “Dead” to assist with quote tracking and inventory forecasting. Other status indicators can include “delivered,” “won,” “cancelled,” “on hold” or other suitable status indicator.

Quotes can be sent by email as PDF or other format documents and can be provided to both the customer and to the user. When a received email containing a quote is opened, its status of the quote can be changed to “viewed” from “sent”. Quotes can display price increases (“adds”) and discounts (“subtracts”). Preferably, quotes can be modified with administrative controls. For example, sales managers can modify quotes but sales representatives cannot.

Additionally, after the completed quote is received, the user can optionally create a brochure depicting the product configuration and parts of the product configuration. The brochure can be a downloadable PDF, a viewable HTML file, or an email with the PDF as an attachment and includes a three-dimensional view of the customized product configuration, as well as enlarged and detailed elevation and side views. The brochure can include all of the dimensions of the product configuration.

The quotes can be generated based on the product configuration using a sales implementation engine with sales, distributor, corporate permissions and visibility rules. The sales implementation engine can further generate drawings, both proposal drawings and dimensioned drawings, and also a specification with costing and part numbers. The sales implementation engine can further collect customer information across many sales for use in creating reports on that information for improved business management.

The configurator tool can act as a sales implementation configurator that is useful in the front end of any manufacturing business. The ability of the tool to generate sales implementation information makes technology such as traditional CRMs and spreadsheet quote templates obsolete. The tool can even export relevant data and information to the enterprise resource planning/materials and/or resource planning software of a customer or potential customer.

In addition, the subject matter of the present disclosure allows for data mining of activity levels, quote statistics, closed and lost opportunities that are coded for the reasons a sale was lost, all of which data are tied to specific products, sales and distribution channels, and margins. If sales are through distributors, the syndicated quote functionality enables the user to see the quote “funnel ” Furthermore, the present technology assures the fast delivery of professionally written proposals to the ultimate customers. Users can follow every facet of the quoting and sales process, including the ability to help the customer customize a design and to obtain a cost proposal.

### Exemplary Computer-Based System for Generating a Product Configuration

FIG. 16 depicts an exemplary computing system 500 that can be used to implement the systems and methods for generating a product configuration and sales implementation information according to an exemplary embodiment of the present disclosure. The system 500 includes a computing device 510. The computing device 510 can be any machine capable of performing calculations automatically. For instance, the computing device can include a general purpose computer, special purpose computer, laptop, desktop, smartphone, tablet, cell phone, mobile device, integrated circuit, or other suitable computing device.

The computing device 510 can have a processor(s) 512 and a memory 514. The computing device 510 can also include a network interface used to communicate with remote computing devices over a network 540. In one exemplary implementation, the computing device 510 can be in communication with a server 530, such as a web server, used to host an application implementing the configurator tool. The computing device can also be in communication with a customer platform 550.

The processor(s) 512 can be any suitable processing device, such as a microprocessor. The memory 514 can include any suitable computer-readable medium or media, including, but not limited to, non-transitory computer-readable media, RAM, ROM, hard drives, flash drives, magnetic or optical media, or other memory devices. The memory 514 can store information accessible by processor(s) 512, including instructions that can be executed by processor(s) 512. The instructions can be any set of instructions that when executed by the processor(s) 512, cause the processor(s) 512 to perform operations. For instance, the instructions can be executed by the processor(s) 512 to implement a configurator tool 516. The configurator tool 516 can allow a user of the computing device to construct a product configuration using affordance-based construction techniques and to view a three-dimensional visualization of the product configuration. The configurator tool 516 can also generate sales implementation information based on the product configuration.

The configurator tool 516 can include, among other components, a visualization engine 518, a rules engine 520, and a sales implementation engine 522. The visualization engine 518 can be configured to present a visual design tool on a display 524 of the computing device 510. The visual design tool can provide a user interface capable of presenting the three-dimensional visualization of the product configuration. The visual design tool can provide affordance-based construction of the product configuration.

The rules engine 520 can be configured to access a set of rules, such as rules stored in a rules database 542 associated with a remote server 530, associated with the product configuration. The rules engine 520 can be further configured to analyze the product configuration for compliance with the set of rules and to modify the product configuration to conform to the set of rules.

The sales implementation engine 522 can be configured to generate sales implementation information based on the product configuration. The sales implementation engine 522 can access customer data, such as customer data stored in a remote customer information database 544 associated with a remote server 530, and product data, such as product data stored in a remote product information database 546 associated with a remote server 530. The sales implementation engine 522 can generate the sales implementation information based on the product configuration, customer data, and product data.

Memory 514 can also include data that can be retrieved, manipulated, created, or stored by processor(s) 512. For instance, memory 514 can store data objects associated with components of a product configuration. The data objects can specify information limited to that which is sufficient to view the component as a three-dimensional object in the three-dimensional visualization. Other information associated with the components can be stored in the remote product information database 546. Processor(s) 512 can use this data to present a three-dimensional visualization of the product configuration.

Computing device 510 can include or can be coupled to one or more input/output devices. Input devices may correspond to one or more peripheral devices configured to allow a user to interact with the computing device. One exemplary input device can be a touch interface 526 (e.g. a touch screen) that allows a user to interact with the system using touch commands. Output device can correspond to a device used to provide information to a user. One exemplary output device includes a display 524 for presenting the user interface including the three-dimensional visualization of the product configuration. The computing device 510 can include or be coupled to other input/output devices, such as a keyboard, microphone, mouse, audio system, printer, and/or other suitable input/output devices. The computing device 510 preferably includes a touch interface 526 so that the user can interact with the configurator tool 516 using touch gestures. Other suitable user interactions can be used without deviating from the scope of the present disclosure.

The server 530 can host an application implementing the configurator tool 532. The server 530 can be configured to exchange data with the computing device 510 over the network 530. For instance, responsive to a request for information, the server 530 can encode data in one or more data files and provide the data files to the computing device 510 over the network 530. Similar to the computing device 510, the server 530 can include a processor(s) and a memory. The server 530 can also include or be in communication with one or more databases, such as a rules database 542, a customer information database 544, and a product information database 546.

According to particular aspects of the present disclosure, the computing device 510 can interface and communicate with a customer platform 550. The customer platform 50 can include customer enterprise applications (CEA). One of these applications can be an enterprise resource planning (ERP) application that integrates internal and external management information across the organization, such as the customer relationship management (CRM) application and the product design management (PDM) application. The purpose of ERP is to facilitate the flow of information among business functions inside the boundaries of the organization and to manage the connection to the outside stakeholders.

The ERP application can continue to operate in real time (or next-to-real time) without relying on updates from the computing device 510. The CRM application can manage interactions using technology to organize, automate and synchronize business processes including sales activities, finding new customers, marketing, customer service and technical support. The PDM application can be used track and control data related to a product, such as technical specifications, specifications and bills of materials for manufacturing and development, materials required and costs associated with the manufacturing of the product. The ERP application, CRM application and PDM application can communicate with the other applications and/or engines in the present system by a suitable application programming interface (API), which is a specification intended to enable applications to communicate with each other.

The network 540 can be any type of communications network, such as a local area network (e.g. intranet), wide area network (e.g. Internet), or some combination thereof The network 540 can also include a direct connection between a computing device 510 and the server 530. In general, communication between the server 530 and a computing device 510 can be carried via either public or private carrier networks using any type of wired and/or wireless connection, and using a variety of communication protocols (e.g. TCP/IP, HTTP, FTP), encodings or formats (e.g. HTML, XML), data encryption and/or protection schemes (e.g. VPN, SSL, SSH, etc.).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of generating a product configuration, the method comprising:
presenting a visual design tool on the display of a computing device, the visual design tool providing a user interface capable of presenting a three-dimensional visualization of the product configuration, the visual design tool configured to provide affordance-based construction of the product configuration;
receiving a first user input generating at least one component of the product configuration;
in response to the first user input, rendering the at least one component in conjunction with an affordance proximate to the at least one component as part of the three-dimensional visualization, the affordance suggesting one or more design modification capabilities to a user;
receiving a second user input directed to the affordance;
modifying the product configuration in response to the second user input directed to the affordance; and
generating, with the computing device, sales implementation information based on the product configuration.

2. The computer-implemented method of claim 1, wherein the three-dimensional visualization can be viewed from a plurality of different perspectives in the user interface.

3. The computer-implemented method of claim 1, wherein the visual design tool provides a virtual diorama in conjunction with the three-dimensional visualization, the virtual diorama providing a background suggestive of an environment of use for the product configuration.

4. The computer-implemented method of claim 3, wherein the virtual diorama is generated based on an image captured by the user.

5. The computer-implemented method of claim 1, wherein the affordance is rendered at least partially overlaying the at least one component in the three-dimensional visualization.

6. The computer-implemented method of claim 1, wherein the affordance provides a guide for attaching one or more additional components to the at least one component, wherein upon receiving the second user input directed to the affordance, the one or more additional components capable of being attached to the at least one component in the product configuration are presented for selection by the user.

7. The computer-implemented method of claim 6, wherein modifying the three-dimensional product configuration in response to the second user input directed to the affordance comprises:
receiving a user input selecting one of the one or more additional components presented for selection by the user; and
adding the selected additional component to the product configuration with dimensions determined based at least in part on the at least one component.

8. The computer-implemented method of claim 1, wherein the affordance is configured to scale the at least one additional component or the product configuration.

9. The computer-implemented method of claim 1, wherein modifying the three-dimensional product configuration in response to the second user input directed to the affordance comprises:
accessing a set of rules associated with the product configuration;
analyzing the product configuration for compliance with the set of rules; and
automatically modifying the product configuration to conform to the set of rules.

10. The computer-implemented method of claim 1, wherein the method further comprises receiving a third user input requesting an isolation view of the at least one component, the isolation view providing an interface for modifying one or more attributes of the at least one component.

11. The computer-implemented method of claim 10, wherein the isolation view provides a carousel interface for modifying one or more attributes of the at least one component.

12. The computer-implemented method of claim 1, wherein the first user input and the second user input comprise a touch gesture.

13. The computer-implemented method of claim 1, wherein generating sales implementation information comprises generating one or more of a quote, a bill of materials, or a purchase order.

14. The computer-implemented method of claim 1, wherein generating sales implementation information based on the product configuration comprises accessing product information stored in a product information database and generating the sales implementation information based on the product information.

15. The computer-implemented method of claim 1, wherein generating sales implementation information based on the product configuration comprises accessing customer information associated with a customer stored in a customer relations manager database and generating the sales implementation information based on the customer information.

16. The computer-implemented method of claim 15, wherein the method comprises:
identifying a customer location using a positioning system; and
identifying the customer information in the customer relations manager database based at least in part on the customer location.

17. A computer-based system for generating a product configuration, the computer-based system comprising a display, one or more processors, and at least one memory, the system comprising:
a visualization engine implemented by the one or more processors, the visualization engine configured to present a visual design tool on the display, the visual design tool providing a user interface capable of presenting a three-dimensional visualization of the product configuration, the visual design tool configured to provide affordance-based construction of the product configuration;
a sales implementation engine implemented by the one or more processors, the sales implementation engine configured to generate sales implementation information based on the product configuration;
wherein in response to a user input generating at least one component of the product configuration, the visualization engine is configured to render an affordance proximate to the at least one component in the three-dimensional visualization, the affordance suggesting one or more design modification capabilities to a user, the visualization engine further configured to process a user input directed to the affordance and to modify the product configuration in response to the user input directed to the affordance.

18. The computer-based system of claim 18, wherein the system further comprises a rules engine implemented by the one or more processors, the rule engine configured to access a set of rules associated with the product configuration, to analyze the product configuration for compliance with the set of rules, and to modify the product configuration to conform to the set of rules.

19. The computer-based system of claim 17, wherein the sales implementation engine is configured to access product information stored in a product information database and to generate the sales implementation information based on the product information.

20. The computer-based system of claim 17, wherein the sales implementation engine is configured to access customer information associated with a customer stored in a customer relations manager database and to generate the sales implementation information based on the customer information.

21. The computer-based system of claim 17, wherein the sales implementation engine is configured to generate the sales implementation information based on data stored in a remote database accessed over a network.

22. A non-transitory computer-readable medium storing computer-readable instructions for execution by a processor to cause the processor to perform operations, the operations comprising:
presenting a visual design tool on the display of a computing device, the visual design tool providing a user interface capable of presenting a three-dimensional visualization of a product configuration, the visual design tool configured to provide affordance-based construction of the product configuration;
receiving a first touch gesture generating at least one component of the product configuration in the visual design tool;
in response to the first touch gesture, rendering the at least one component in conjunction with an affordance proximate to the at least one component as part of the three-dimensional visualization, the affordance suggesting one or more design modification capabilities to the user;
receiving a second touch gesture directed to the affordance;
modifying the product configuration in response to the second user input direct to the affordance;
receiving a user input requesting a quote for the product configuration; and
in response to the user input, generating the quote based on the product configuration.
